(19) United States
(12) Patent Application Publication
(10) Pub. No.: US 2015/0295793 A1
(43) Pub. Date: Oct. 15, 2015

(54) HIGH-PERFORMANCE COMPUTING EVALUATION

(71) Applicant: International Business Machines Corporation, Armonk, NY (US)

(72) Inventors: Robert Maher, Wappingers Falls, NY (US); Elisabeth R. Stahl, Shaker Heights, OH (US); Clarisse T. Taaffe-Hedglin, Charlotte, NC (US)

(73) Assignee: International Business Machines Corporation, Armonk, NY (US)

(21) Appl. No.: 14/249,500

(22) Filed: Apr. 10, 2014

(51) Int. Cl. H04L 12/26

(52) U.S. Cl. CPC H04L 43/04; H04L 43/08

(57) ABSTRACT

In one embodiment, a computer-implemented method includes iteratively running a client application on two or more combinations of two or more hardware platforms and one or more software products, where the two or more hardware platforms and the one or more software products reside in an integrated evaluation appliance. The running of the client application on the two or more combinations is monitored by a computer processor. A result of running the client application on a first hardware platform and a result of running the client application on a second hardware platform are output, where the first hardware platform and the second hardware platform are among the two or more hardware platforms residing in the evaluation appliance.

### BACKGROUND

Various embodiments of this disclosure relate to high-performance computing and, more particularly, to determining appropriate high-performance computing configurations for client applications.

Cloud computing is a flexible and cost-effective delivery platform for providing information technology (IT) services over the Internet. Generally, deployments of specific cloud computing environments for various applications are based on workload characterization and non-functional business requirements related to those applications.

Many organizations are now moving from public clouds to private clouds, each of which is individually owned and used. Private clouds offer many of the same benefits as public clouds, and they give their owners greater flexibility and control. Advantages of a private cloud over a public cloud include, for example, increased customizability, efficiency, constant availability, resiliency, security, and privacy. Private clouds can also provide lower latency than public clouds during peak periods, unlike public clouds, which are impacted by the uses of other individuals or organizations sharing the cloud.

Some organizations embrace both public and private cloud computing by integrating the two models into hybrid clouds, also known as dynamic clouds, which are bound together by standardized or proprietary technology enabling data and application portability. A hybrid cloud may contain multiple services and various combinations of providers and consumers. In general, hybrid clouds are designed to meet specific business and technology requirements. Hybrids can help optimize security and privacy with smaller investment than private clouds, and with fixed IT costs.

Optimizing performance for cloud computing solutions is a complex problem. The scope, variability, and integration are sophisticated issues, and performance metrics go far beyond legacy requirements, such as response time and throughput. Consumability issues, such as deployment time, density, elasticity, resiliency, backup, and maintenance, are increasingly important as well. Virtualization and hardware technologies can play a key role in determining these factors.

This complexity is of particular concern for high-performance computing (HPC) organizations. Their business goals and productivity are tightly coupled with application goals, such as turnaround time for results. HPC organizations often struggle with evaluating systems to determine what combination of hardware and software will meet their application goals. These goals and expectations can vary from one organization to the next. A focus of such goals can be, for example, achieving optimal execution time, multi-user throughput, energy efficiency, automation, provisioning, resource usage, or finding the right balance between competing goals.

When organizations evaluate hardware platforms, they are faced with choices in architectures, such as multi-core processors, memory design, and hardware accelerators. These hardware decisions also drive the definitions of optimal input/output (I/O) subsystems and network topologies. Software choices include firmware settings, operating systems, compilers, messaging, and optimization libraries and are often driven by parallel programming models that can favor scale-up (i.e. more tightly coupled cores within a server), scale-out (i.e., more tightly coupled nodes), or emerging hybrid and cloud approaches. A third dimension of system evaluation is tuning of hardware and software in concert. Memory placement and allocation can impact application latency and bandwidth. Energy management features can impact power consumption and performance. Leveraging advanced network adapter features and low-level communication layers can significantly change application behavior.

To make informed choices in selecting computing platforms, client organizations have relied on vendor information, proof of concept (POC), industry standards, or customized benchmarks that provide static proof points for specific environments. However, vendor component feeds and speeds are not representative of client applications and don't capture client usage. POCs and benchmarks capture a point-in-time view of a specific environment and are costly and time-consuming approaches to system evaluation. Further, POCs and benchmarks typically do not capture the full capability of what hybrid systems found in cloud computing environments can deliver.

### SUMMARY

In one embodiment of this disclosure, a computer-implemented method includes iteratively running a client application on two or more combinations of two or more hardware platforms and one or more software products, where the two or more hardware platforms and the one or more software products reside in an integrated evaluation appliance. The running of the client application on the two or more combinations is monitored by a computer processor. A result of running the client application on a first hardware platform and a result of running the client application on a second hardware platform are output, where the first hardware platform and the second hardware platform are among the two or more hardware platforms residing in the evaluation appliance.

In another embodiment, an evaluation appliance includes two or more hardware platforms and a portal. The two or more hardware platforms are configured to run a client application, where the client application is run iteratively on two or more combinations of the two or more hardware platforms and one or more software products. The portal is configured to monitor the running of the client application on the two more combinations; and to output a result of running the client application on a first hardware platform and a result of running the client application on a second hardware platform, where the first hardware platform and the second hardware platform are among the two or more hardware platforms.

In yet another embodiment, a computer program product includes a computer readable storage medium having computer readable program code embodied thereon. The computer readable program code is executable by a processor to perform a method. The method includes iteratively running a client application on two or more combinations of two or more hardware platforms and one or more software products, where the two or more hardware platforms and the one or more software products reside in an integrated evaluation appliance. Further according to the method, the running of the client application on the two or more combinations is monitored. A result of running the client application on a first hardware platform and a result of running the client application on a second hardware platform are output, where the first hardware platform and the second hardware platform are among the two or more hardware platforms residing in the evaluation appliance.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of an evaluation system, embodied in an evaluation appliance, according to some embodiments of this disclosure;

FIG. 2 is a flow diagram of an evaluation method, according to some embodiments of this disclosure; and

FIG. 3 is a block diagram of a computing device for implementing some or all aspects of the evaluation system and method, according to some embodiments of this disclosure.

### DETAILED DESCRIPTION

Various embodiments of this disclosure are systems, methods, and computer program products related to, or residing at least in part in, a high-performance computing evaluation appliance. The appliance may be a combination of hardware and software, including tools that may be used to define solution recommendations for a client's applications. In some embodiments, the appliance may include multiple hardware platforms on which an application can run, thus enabling evaluation of the various platforms and various software with respect to that application.

The appliance may be packaged, for example, in a self-contained enclosure with a front-end portal that guides the client through the evaluation process. The appliance may contain one or more hardware platforms and one or more software products, used in combination to run and evaluate one or more client applications through various iterative optimization paths. The appliance may report the evaluation results relative to the client's application goals, e.g. achieving optimal execution time, multi-user throughput, energy efficiency, automation, provisioning, resource usage. In some embodiments, the appliance may be used by the client in the context of a cloud computing environment or other computing environment to guide optimal resource selection for the environment. The appliance may also be used prior to building a computational environment by recommending optimal platforms.

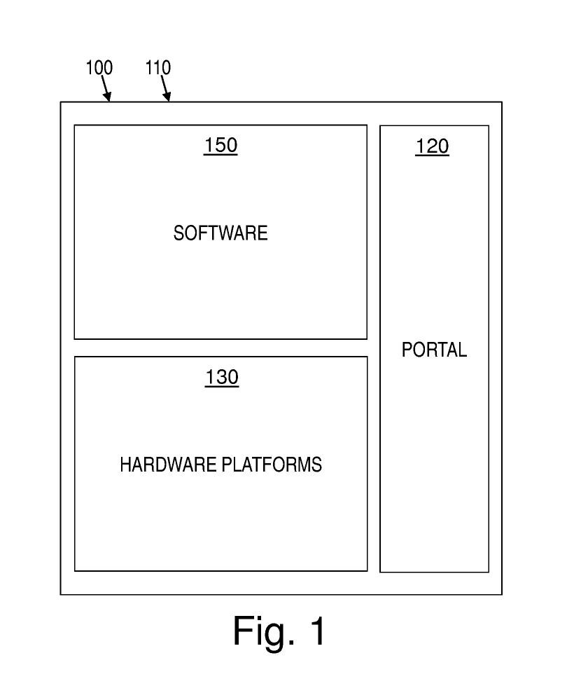

FIG. 1 is a block diagram of an evaluation system 100, encapsulated in an evaluation appliance 110, according to some embodiments of this disclosure. As shown, the evaluation system 100 may include a front-end portal 120, one or more hardware platforms 130, and one or more software products 150. Each platform 130 may be configured to run one or more client applications. The portal 120 may include tools for monitoring the various platforms 130 during execution of the applications. Through the portal 120, the evaluation appliance 110 may output an evaluation of the various platforms' performances and make recommendations for improving one or more of the platforms 130.

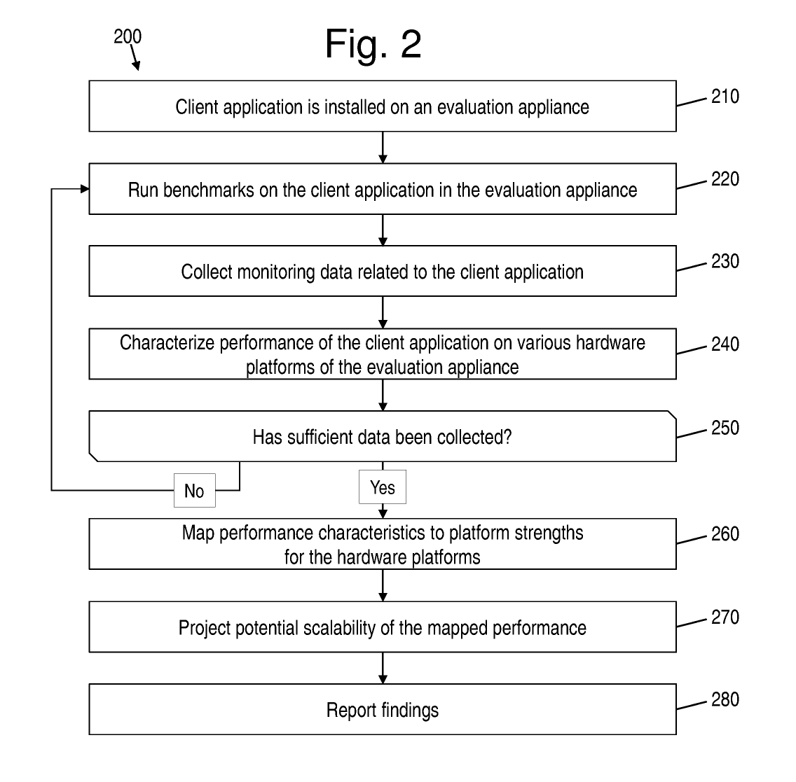

FIG. 2 is a flow diagram of a method 200 for evaluating one or more platforms 130 with respect to the client's applications, according to some embodiments of this disclosure. It will be understood that embodiments of this disclosure need not be limited to the method 200 shown here.

Prior to the beginning of the illustrated method 200, the client may communicate to a provider of the evaluation appliance 110. For example, this initial communication may take the form of a telephone call, web-based form, email message, or other mechanism for communicating information. In this communication, the client may indicate its computing needs for running one or more applications, including, for example, sample workloads, goals, or a combination of both. In response to the communication, the provider may establish an evaluation plan, which may be a plan to evaluate the client's needs with an appropriately configured evaluation appliance 110.

The initial configuration of the appliance, with respect to hardware platforms 130 and software 150, may be based on the details provided by the client in the communication. The build platforms 130 and software 150 may be further selected by the provider based on expert decision-making techniques, such as those currently used to configure systems for high-performance computing. In addition to the hardware platforms 130 and software 150, the evaluation appliance 110 may also include evaluation tools for evaluating the client's one or more applications. These tools may be incorporated into the portal 120 in some embodiments.

The provider may then confirm that the resulting evaluation appliance 110 meets the evaluation plan for the client. If it does not meet the evaluation plan for some reason, then the evaluation appliance 110 may be modified or replaced with a new evaluation appliance 110, until an appropriate appliance 110 is produced. This modification may include, for example, swapping out hardware, installing or uninstalling software, or other modifications. To this end, the evaluation appliance 110 may be configured to be modifiable. After an appropriate evaluation appliance 110 is produced, the provider may then provide that resulting evaluation appliance 110 to the client in response to the initial communication.

When the client has possession of the evaluation appliance, at block 210, the client may install its own one or more applications and compile workloads for those applications, such as through the use of automated scripts. At block 220, the client may run benchmarks on the evaluation appliance 110. Thus, the benchmark results may be based on actual client workloads, or sample workloads provided by the client. As a result, these benchmark results may be more accurate than conventional benchmark results, which are based on simulations performed by the provider to merely approximate what the client intends to do.

At block 230, monitoring data may be collected from the evaluation appliance 110 and stored in a repository, which may be a temporary repository. Because the evaluation appliance 110 may include multiple platforms, the applications may thereby run on multiple platforms 130, which may each produce distinct results with respect to the benchmarks and the monitoring data. In some embodiments, the evaluation appliance 110 may iteratively run the application benchmarks on various combinations of hardware platforms 130 and software 150. Further, the evaluation appliance 110 may virtualize hardware that is not contained in the appliance 110, thus enabling itself to run the application benchmarks on additional platforms 130 for which hardware is not present.

After some monitoring has been performed, at block 240, the evaluation appliance 110 may characterize the performance of the applications, based on the benchmarks, the monitoring data, or a combination of both. At decision block 250, it may be determined whether sufficient data has been collected to determine whether the applications are running as desired by the client. Such determination may be made by the client or, in some embodiments, may be made by the evaluation appliance 110 based on predetermined parameters. If more data is needed to determine whether the results are sufficient, the evaluation appliance 110 may continue to run the application benchmarks, at block 220, and monitor the applications, at block 230. At block 260, the evaluation appliance 110 may map performance characteristics to platform strengths for the various platforms 130 running on the appliance 110. In other words, the evaluation appliance 110 may determine which platforms 130 succeed in which respects (e.g., fast processing, accuracy, utilization) relative to the client's application goals. At block 270, the evaluation appliance 110 may project the potential scalability of the mapped performance on the various platforms 130. The evaluation appliance 110 may then report its findings, at block 280. The reported findings may include, for example, for each platform 130: platform details, software stack, processor characteristics, memory characteristics, communications characteristics, scaling capability, and tuning notes (i.e., recommended modifications).

In some embodiments, the evaluation appliance 110 may report the findings through the portal 120, which may display the findings to the client. The report may provide a distinct set of results for each platform 130, and may also compare the platforms 130, thus enabling the client to determine which platforms 130 perform as desired for the client's applications. Additionally, the report may make recommendations for modifying one or more of the platforms 130 for further improvement with respect to the client's goals. In some embodiments, the report may additionally be transmitted back to the provider.

After the findings have been reported, the provider and client may determine an appropriate computing configuration for the client. For example, and not by way of limitation, if there is a particular platform 130, or a particular combination of hardware platform 130 and software 150, that meet the client's requirements or perform closest to the client's requirements, then that platform 130 or combination may be deemed appropriate for the client's needs. Thus, the provider may provide to the client a computing configuration according to that platform 130 or combination. In some instances, provision of the desired platform 130 may include modifying the evaluation appliance 110 so the client may use the modified appliance as its final high-performance computing system. In some other instances, however, the provider may provide the client with a separate system to use.

Thus, the evaluation appliance's output may be used to support the client's purchase decision for a system in a computing cloud environment or other computing environment. Further, because the client has the actual evaluation appliance 110 at hand during evaluation, the appliance 110 may be integrated into the client's environment and used to direct the right resources to the right workload with measured feedback, thereby producing realistic results and providing realistic recommendation. A further benefit of the evaluation appliance 110, in some embodiments, is the flexibility in supporting multiple platforms 130, swapping components as needed to modify the appliance 110, and leveraging cloud and virtualization technologies to simulate end client environments.

It will be understood that various hardware and software may be used in the evaluation appliance 110, and that the configuration of the evaluation appliance 110 may be customized for a particular client's needs. For example, a particular embodiment of an evaluation appliance 110 may include the following hardware making up the hardware platforms 130: POWER7, Intel blades, AMD servers, NVIDIA accelerator, internal and external disk drives, 10 GigE, IB network adapters and switches. That same appliance 110 may include the following software 150: OS distributions, compilers, MPI and OpenMP Message passing libraries, mathematics libraries, cloud management suite, profiling and tracing tools, setup scripts, predictive expert system, and reporting scripts. The portal 120 of that same appliance 110 may include, for example: instructions for design of experiments, process flow, report generation, and sample demos. However, it will be understood that this example configuration does not limit the various options for the evaluation appliance 110.

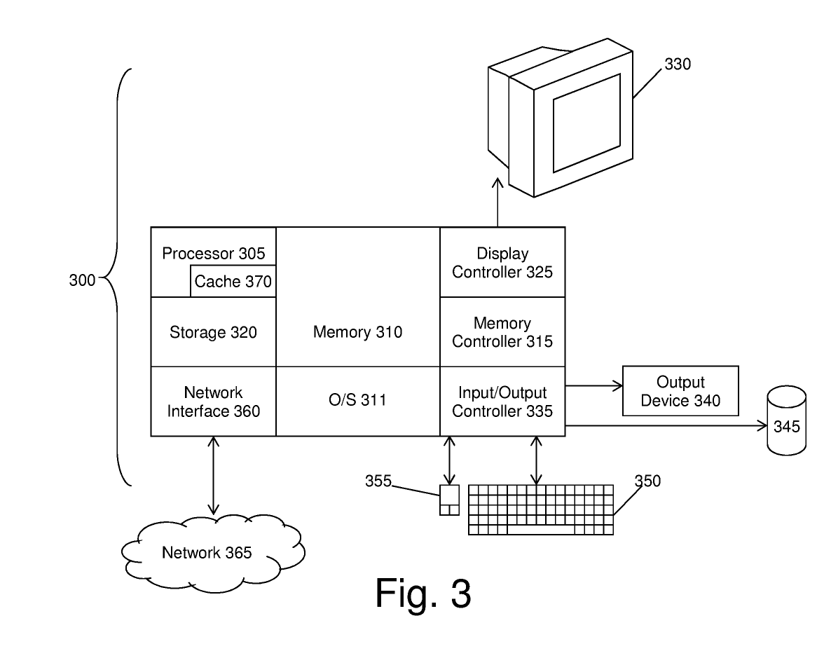

FIG. 3 illustrates a block diagram of a computer system 300 for use in implementing an evaluation system 100 or method 200 according to some embodiments of this disclosure. For instance, such a computer system 300 may be used as the evaluation appliance. The evaluation systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 300, such as a personal computer, workstation, minicomputer, or mainframe computer.

In an exemplary embodiment, as shown in FIG. 3, the computer system 300 includes a processor 305, memory 310 coupled to a memory controller 315, and one or more input devices 345 and/or output devices 340, such as peripherals, that are communicatively coupled via a local I/O controller 335. These devices 340 and 345 may include, for example, a printer, a scanner, a microphone, and the like. A conventional keyboard 350 and mouse 355 may be coupled to the I/O controller 335. The I/O controller 335 may be, for example, one or more buses or other wired or wireless connections, as are known in the art. The I/O controller 335 may have additional elements, which are omitted for simplicity, such as controllers, buffers (caches), drivers, repeaters, and receivers, to enable communications.

The I/O devices 340, 345 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 305 is a hardware device for executing hardware instructions or software, particularly those stored in memory 310. The processor 305 may be any custom made or commercially available processor, a central processing unit (CPU), an auxiliary processor among several processors associated with the computer system 300, a semiconductor based microprocessor (in the form of a microchip or chip set), a macroprocessor, or other device for executing instructions. The processor 305 includes a cache 370, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 370 may be organized as a hierarchy of more cache levels (L1, L2, etc.).

The memory 310 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 310 may incorporate electronic, magnetic, optical, or other types of storage media. Note that the memory 310 may have a distributed architecture, where various components are situated remote from one another but may be accessed by the processor 305.

The instructions in memory 310 may include one or more separate programs, each of which comprises an ordered listing of executable instructions for implementing logical functions. In the example of FIG. 3, the instructions in the memory 310 include a suitable operating system (OS) 311. The operating system 311 essentially may control the execution of other computer programs and provides scheduling, input-output control, file and data management, memory management, and communication control and related services.

Additional data, including, for example, instructions for the processor 305 or other retrievable information, may be stored in storage 320, which may be a storage device such as a hard disk drive or solid state drive. The stored instructions in memory 310 or in storage 320 may include those enabling the processor to execute one or more aspects of the evaluation systems and methods of this disclosure.

The computer system 300 may further include a display controller 325 coupled to a display 330. In an exemplary embodiment, the computer system 300 may further include a network interface 360 for coupling to a network 365. The network 365 may be an IP-based network for communication between the computer system 300 and any external server, client and the like via a broadband connection. The network 365 transmits and receives data between the computer system 300 and external systems. In an exemplary embodiment, the network 365 may be a managed IP network administered by a service provider. The network 365 may be implemented in a wireless fashion, e.g., using wireless protocols and technologies, such as WiFi, WiMax, etc. The network 365 may also be a packet-switched network such as a local area network, wide area network, metropolitan area network, the Internet, or other similar type of network environment. The network 365 may be a fixed wireless network, a wireless local area network (LAN), a wireless wide area network (WAN) a personal area network (PAN), a virtual private network (VPN), intranet or other suitable network system and may include equipment for receiving and transmitting signals.

Evaluation systems and methods according to this disclosure may be embodied, in whole or in part, in computer program products or in computer systems 300, such as that illustrated in FIG. 3.

Technical effects and benefits of the evaluation systems and methods include, for example: reusing data for future benchmark activities, which can save cost and time; characterizing applications, such as based on CPU intensiveness, memory intensiveness, input/output (I/O) intensiveness, or network intensiveness; characterizing systems used in benchmarking so as to answer questions regarding which platforms will better run the application in question; identifying system bottlenecks to assist in computing system redesign; identifying application bottlenecks for performance tuning and algorithm redesign; improving quality control of benchmark results; conducting performance modeling and projection; providing valuable input into cloud resources selection and usage; improving accessibility to more clients through innovative packaging in the form of an integrated appliance; and creating new business opportunities to present appropriate solutions to clients.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-7. (canceled)

8. An evaluation appliance comprising:
two or more hardware platforms configured to run a client application, wherein the client application is run iteratively on two or more combinations of the two or more hardware platforms and one or more software products; and
a portal configured to:
monitor the running of the client application on the two more combinations; and
output a result of running the client application on a first hardware platform and a result of running the client application on a second hardware platform, wherein the first hardware platform and the second hardware platform are among the two or more hardware platforms.

9. The evaluation appliance of claim 8, wherein the portal is further configured to run the client application on a virtualized hardware platform residing in the evaluation appliance.

10. The evaluation appliance of claim 8, wherein the result of running the client application on the first hardware platform comprises a recommendation for modifying the first hardware platform.

11. The evaluation appliance of claim 8, wherein the result of running the client application on the first hardware platform and the result of running the client application on the second hardware platform comprise results that are relative to a client's predetermined goals for the client application.

12. The evaluation appliance of claim 8, wherein the result of running the client application on the first hardware platform comprises an indication of scalability of the client application.

13. The evaluation appliance of claim 8, wherein the result of running the client application on the first hardware platform and the result of running the client application on the second hardware platform each comprise indication of a corresponding hardware platform, software stack information, and at least one of tuning notes, scalability capability, and tuning notes, for each of the two or more combinations of the two or more hardware platforms and the one or more software products.

14-20. (canceled)
